(19) United States
(12) Patent Application Publication
(10) Pub. No.: US 2018/0109134 A1
(43) Pub. Date: Apr. 19, 2018

(54) POWER MONITORING FOR OUTPUT VOLTAGE SUPPORT

(71) Applicant: Intersil Americas LLC, Milpitas, CA (US)

(72) Inventors: John CARPENTER, Holly Springs, NC (US); Mehul SHAH, Cary, NC (US)

(21) Appl. No.: 15/649,233

(22) Filed: Jul. 13, 2017

Related U.S. Application Data
(60) Provisional application No. 62/407,966, filed on Oct. 13, 2016.

(51) Int. Cl. H02J 9/06; G06F 1/26

(52) U.S. Cl. CPC H02J 9/061; H02J 2009/068; G06F 1/263

(57) ABSTRACT

The present embodiments relate generally to methods and apparatuses for providing supplemental output voltage support in a battery charger. According to certain aspects, to provide supplemental power in a system with a weak battery and high current load, embodiments provide a trigger value to alert the system and a pre-trigger to allow saving current. Some embodiments use current information to predict the need for supplemental mode. These and other embodiments provide prepared biasing for faster response times, and are more precise than monitoring voltage alone. These and other embodiments further preferably provide support for providing supplemental system power while protecting attached external devices.

### CROSS-REFERENCE TO RELATED APPLICATIONS

The present application claims priority to U.S. Provisional Application No. 62/407,966 filed Oct. 13, 2016, the contents of which are incorporated by reference herein in their entirety.

### TECHNICAL FIELD

Embodiments disclosed herein relate generally to power control, and more particularly to methods and apparatuses for monitoring power for output voltage support.

### BACKGROUND

Battery chargers, in particular battery chargers for mobile computing devices, are evolving beyond just being responsible for charging a battery when a power adapter is connected. For example, conventional mobile computing devices such as laptop or notebook computers include a dedicated and typically proprietary plug-in port for a power adapter. When the adapter is plugged in to this dedicated port, the battery charger is responsible for charging the battery using the adapter voltage specified by the manufacturer of the mobile computing device. Relatedly, most conventional mobile computing devices also include standardized interfaces such as Universal Serial Bus (USB) ports. When an external device is plugged into such a USB port, the mobile computing device can exchange data with the external device using the well-known USB protocol. Moreover, the USB standard allows the connected external device (e.g. a smartphone with a micro USB port) to receive power from the mobile computing device via the mobile computing device's USB interface, for example to charge the external device's own battery. Accordingly, conventional battery chargers are further responsible for supplying power to the external device, including from the mobile computing device's own battery when a power adapter is not connected.

Recently, some mobile computing device manufacturers have moved toward replacing the typically separate and proprietary power adapter port with USB ports supporting the newer USB Type C (USB-C) or USB Power Delivery (USB PD) protocols. USB-C supports bi-directional power flow at a much higher level than previous versions of the USB interface (e.g. 5V). Starting from a default 5V voltage, the USB-C port controller is capable of negotiating with the plugged-in device to raise the port voltage to 12V, 20V, or another mutually agreed on voltage, at a mutually agreed current level. The maximum power a USB-C port can deliver is 20V at 5 A current, which is 100 W of power—more than adequate to charge a computer, especially since most 15-inch Ultrabooks require just around 60 W of power.

Conventional battery chargers will need to change when mobile system manufacturers transition to using power adapters that connect to the USB-C port. The battery charger must be capable of charging a battery for a mobile computing device (e.g. an Ultrabook having a 1-, 2-, 3- or 4-cell battery stack) with power from a USB-C adapter having a 5V-20V range. Future battery chargers will also need to accommodate charging external electronic devices such as tablets, smartphones, power banks and more that connect to the mobile computing device via the USB-C port.

### SUMMARY

The present embodiments relate generally to methods and apparatuses for providing supplemental output voltage support in a battery charger. According to certain aspects, to provide supplemental power in a system with a weak battery and high current load, embodiments provide a trigger value to alert the system and a pre-trigger to allow saving current. Some embodiments use current information to predict the need for supplemental mode. These and other embodiments provide prepared biasing for faster response times, and are more precise than monitoring voltage alone. These and other embodiments further preferably provide support for providing supplemental system power while protecting attached external devices.

### BRIEF DESCRIPTION OF THE DRAWINGS

These and other aspects and features of the present embodiments will become apparent to those ordinarily skilled in the art upon review of the following description of specific embodiments in conjunction with the accompanying figures, wherein:

FIG. 1 is a block diagram illustrating aspects of incorporating embodiments in a system having a CPU;

FIG. 2 is a schematic diagram of an example application of a battery charger according to embodiments using an integrated circuit;

FIG. 3A is a schematic diagram illustrating aspects of embodiments operating in a normal battery only mode;

FIG. 3B is a schematic diagram illustrating aspects of embodiments operating OTG from a normal battery only mode;

FIG. 3C is a schematic diagram illustrating aspects of embodiments operating in a fill reservoir mode;

FIG. 3D is a schematic diagram illustrating aspects of embodiments operating in a monitor power mode;

FIG. 3E is a schematic diagram illustrating aspects of embodiments operating in a supplemental mode;

FIG. 4 is a flowchart illustrating aspects of an example methodology according to embodiments.

### DETAILED DESCRIPTION OF THE PREFERRED EMBODIMENTS

The present embodiments will now be described in detail with reference to the drawings, which are provided as illustrative examples of the embodiments so as to enable those skilled in the art to practice the embodiments and alternatives apparent to those skilled in the art. Notably, the figures and examples below are not meant to limit the scope of the present embodiments to a single embodiment, but other embodiments are possible by way of interchange of some or all of the described or illustrated elements. Moreover, where certain elements of the present embodiments can be partially or fully implemented using known components, only those portions of such known components that are necessary for an understanding of the present embodiments will be described, and detailed descriptions of other portions of such known components will be omitted so as not to obscure the present embodiments. Embodiments described as being implemented in software should not be limited thereto, but can include embodiments implemented in hardware, or combinations of software and hardware, and vice-versa, as will be apparent to those skilled in the art, unless otherwise specified herein. In the present specification, an embodiment showing a singular component should not be considered limiting; rather, the present disclosure is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present embodiments encompass present and future known equivalents to the known components referred to herein by way of illustration.

According to certain general aspects, the present embodiments relate to methods and apparatuses for operating a battery charger in computing systems having certain system load requirements, battery configurations and external device power supply support.

For example, as set forth above, in accordance with some aspects, the present applicant recognizes that the traditional power architecture will need to change when mobile system manufacturers transition to adapters using the USB-C port.

Meanwhile, the present applicant further recognizes that certain issues arise when mobile systems include processors that incorporate Intel Mobile Voltage Positioning (IMVP) technology. IMVP is a technology that is built into a voltage regulator (VR) that supplies electrical power to the processor. The unique feature of IMVP technology is that the processor voltage is dynamically adjusted based on the processor activity to reduce processor power. Traditional processor voltage regulators keep the processor voltage at a static voltage over all processor activity states.

Still further, the present applicant recognizes that certain issues arise when mobile computing systems include support for USB On-The-Go functionality, often abbreviated to USB OTG or just OTG. In general, USB OTG is a specification first used in late 2001 that allows USB devices, such as tablets or smartphones, to act as a host, allowing other USB devices, such as USB flash drives, digital cameras, mice or keyboards, to be attached to them. Use of USB OTG allows those devices to switch back and forth between the roles of host and device. For instance, a mobile phone may read from removable media as the host device, but present itself as a USB Mass Storage Device when connected to a host computer. When a mobile computing system having USB OTG support is operating as a host, a battery charger incorporated in such a system must be able to supply power to the connected device, including when the mobile computing system is operating in a battery only mode. Accordingly, the present embodiments incorporate techniques for providing such USB OTG power supply support.

In view of these and other observations by the present applicant, embodiments disclosed herein relate to methods and apparatuses for providing supplemental output voltage support in a battery charger. According to certain aspects, to provide supplemental power in a system with a weak battery and high current load, embodiments provide a trigger value to alert the system and a pre-trigger to allow saving current. Some embodiments use current information to predict the need for supplemental mode. These and other embodiments provide prepared biasing for faster response times, and are more precise than monitoring voltage alone. These and other embodiments further preferably provide support for providing supplemental system power while protecting attached external devices.

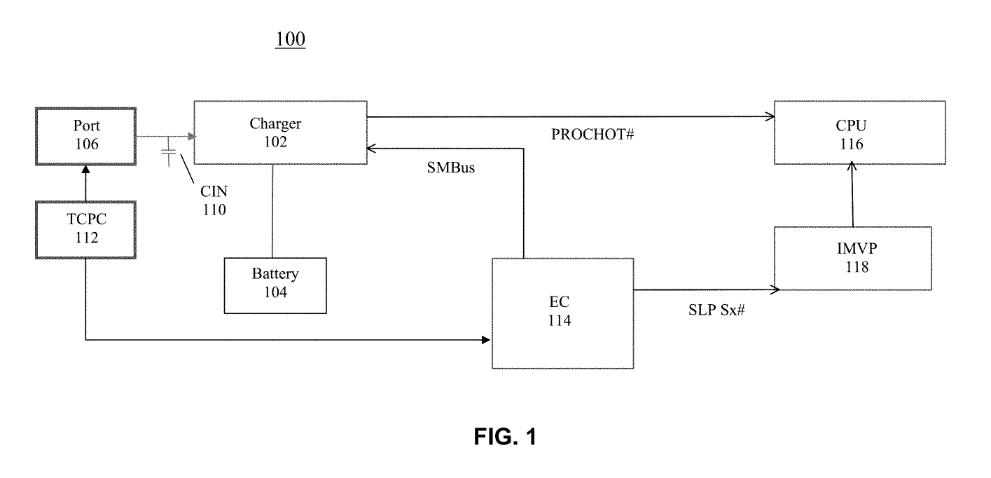

FIG. 1 is a block diagram illustrating aspects of incorporating the present embodiments in an example system 100. System 100 is a mobile computing device such as a notebook computer (e.g. MacBook, Ultrabook, etc.), laptop computer, pad or tablet computer (iPad, Surface, etc.), etc. In these and other embodiments, system 100 includes CPU 116 running a conventional operating system such as Windows or Apple OS. As will become more apparent below, the present embodiments find particularly useful application when CPU 116 is an Intel x86 processor that incorporates IMVP technology. However, other embodiments can be practiced when CPU 116 is a compatible x86 processor from AMD or other manufacturers, as well as other processors made by Freescale, Qualcomm, etc. It should be apparent that system 100 can include many other components not shown such as solid state and other disk drives, memories, peripherals, displays, user interface components, etc. According to certain aspects, a system 100 in which the present embodiments can find particularly useful application has operational power needs that can exceed the power limits of technologies such as USB-A, for example over 60 watts. However, the present embodiments are not limited to applications in such systems.

As shown, system 100 includes a battery 104 and a battery charger 102. According to certain general aspects, during normal operation of system 100, when a power adapter is plugged into port 106, battery charger 102 is configured to charge battery 104. Preferably, in addition to charging battery 104, battery charger 102 is further adapted to convert the power from the adapter to a voltage suitable for supplying to components of the system 100, including CPU 116. According to certain other general aspects, during normal operation of system 100, when a power adapter is not plugged into port 106, battery charger 102 is configured to manage the supply of power to the system from battery 104. Moreover, as shown in the example of FIG. 1 and as will be described in more detail below, during a battery only mode, when charger 102 detects that system voltage droops below a predefined threshold voltage, it asserts a PROCHOT# signal to CPU 116 and supplements the power to the system from capacitor CIN 110.

Embodiments of battery charger 102 will be described in more detail below. In notebook computer (e.g. Ultrabook) and other embodiments of system 100, battery 104 can be a rechargeable 1S/2S/3S/4S (i.e. 1 cell, 2 cell, 3 cell, or 4 cell stack) Lithium-ion (Li-ion) battery. In these and other embodiments, port 106 can be a Universal Serial Bus (USB) port, such as a USB Type C (USB-C) port or a USB Power Delivery (USB PD) port. Although not shown in FIG. 1, switches between port 106 and charger 102 can also be provided for controllably coupling power from an adapter connected to port 106 to charger 102, or alternatively providing system power to charger 102 and/or port 106. Such switches can also include or be implemented by active devices such as back-to-back FETs.

As further shown, example system 100 includes an input capacitor 110 in the connection path between port 106 and charger 102. According to aspects of embodiments to be described in more detail below, charger 102 is configured to manage and use input capacitor 110 as a reservoir for certain protection scenarios of system 100, such as for supplementing battery power when system voltage drops below a threshold and an adapter is not attached to port 106.

Still further, example system 100 in which the present embodiments can find useful applications includes a Type C port controller (TCPC) 112, an embedded controller (EC) 114, and an IMVP module 118. According to certain general aspects relevant to the present embodiments, TCPC 112 includes functionality for detecting the type of USB device connected to port 116, controlling switches associated with connecting port 106 to system 100, and for communicating port status to EC 114 (e.g. via an I2C interface). EC 114 is generally responsible for managing power configurations of system 100 (e.g. power adapter connected or not connected to port 106 as communicated to EC 114 from TCPC 112, etc.), receiving battery status from battery 104, and for communicating battery charging and other control information to charger 102 (e.g. via SMbus interface).

IMVP module 118 implements IMVP power savings technology for supplying power to CPU 116, for example in accordance with information communicated to IMVP module 118 from EC 114. According to some aspects, battery charger 102 includes support for IMVP technology such as that implemented by module 118. For example, some versions of IMVP require that battery chargers include several operational features such as active protection for certain minimum voltage conditions, such as when there are peak power demands by the processor while the system is operating in battery only mode, including when the battery is weak. Accordingly, as will be described in more detail below, charger 102 according to the present embodiments incorporates techniques for providing such protection.

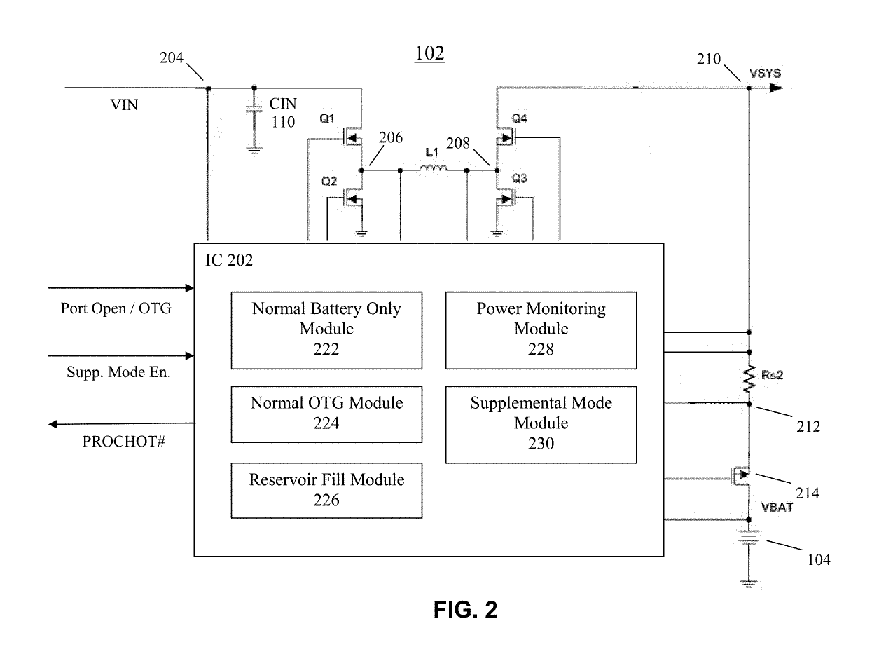

FIG. 2 is a schematic diagram of an example implementation of the present embodiments using an integrated circuit 202.

More particularly, as shown, input capacitor CIN 110 is coupled between input node 204, which is coupled to port 106 (not shown), and GND. The example charger 102 in these embodiments includes a plurality of power switching transistors including a field-effect transistor (FET) Q1, having its drain coupled to node 204 and its source coupled an intermediate node 206. Another FET Q2 has its drain coupled to node 206 and its source coupled to GND. The charger 102 includes an inductor L1 coupled between node 206 and the node 208. The example charger 102 in these embodiments further includes FET Q4, having its drain coupled to output node 210 and its source coupled an intermediate node 208. Another FET Q3 has its drain coupled to node 208 and its source coupled to GND. As shown, output node 210 provides a system voltage VSYS to a system load such as CPU 116.

Charger 102 in this example further includes a sense resistor Rs2 coupled between output node 210 and an intermediate node 212. Another FET 214 has its source coupled to node 212 and its drain coupled to the rechargeable battery 104 developing the battery voltage VBAT. The gate of FET 212 is coupled to the IC 202 for controlling charge and discharge of the rechargeable battery 104. For example, when the power adapter is not connected, the FET 214 may be turned fully on to provided power to the system load via VSYS. When the power adapter is connected, the FET 214 may be controlled in a linear manner to control charging of the rechargeable battery 104.

The FETs Q1, Q2, Q3, Q4 and 214 are shown implemented using N-channel MOSFETs, although other types of switching devices are contemplated, such as P-channel devices, other similar forms (e.g., FETs, MOS devices, etc.), bipolar junction transistor (BJTs) and the like, insulated-gate bipolar transistors (IGBTs) and the like, etc.

As shown, IC 202 according to the present embodiments includes modules 222, 224, 226, 228 and 230 that control operation of transistors Q1, Q2, Q3 and Q4 via output connections to the gates thereof in accordance with port status and supplemental mode enable signals from TCPC 112 and/or EC 114, as well as from other information received via connections to the IC 202 such as the input voltage VIN, the inductor current across L1, and the battery 104 voltage VBAT and current (e.g., via connections to the terminals at either end of resistor Rs2) as will become more apparent below.

Modules 222, 224, 226, 228 and 230 are shown separately for ease of illustration but can include common circuitry, including circuitry also shared by modules for controlling other operations of system 100 by IC 202. Additionally and relatedly, although the present descriptions will focus on IC 202 operating in a battery only mode, it should be apparent that IC 202 can include additional functionality for operating in other modes, such as when a power adapter is connected to port 106 and battery 104 is charging. The details of such additional functionality and/or circuitry will be omitted here for sake of clarity of the present embodiments.

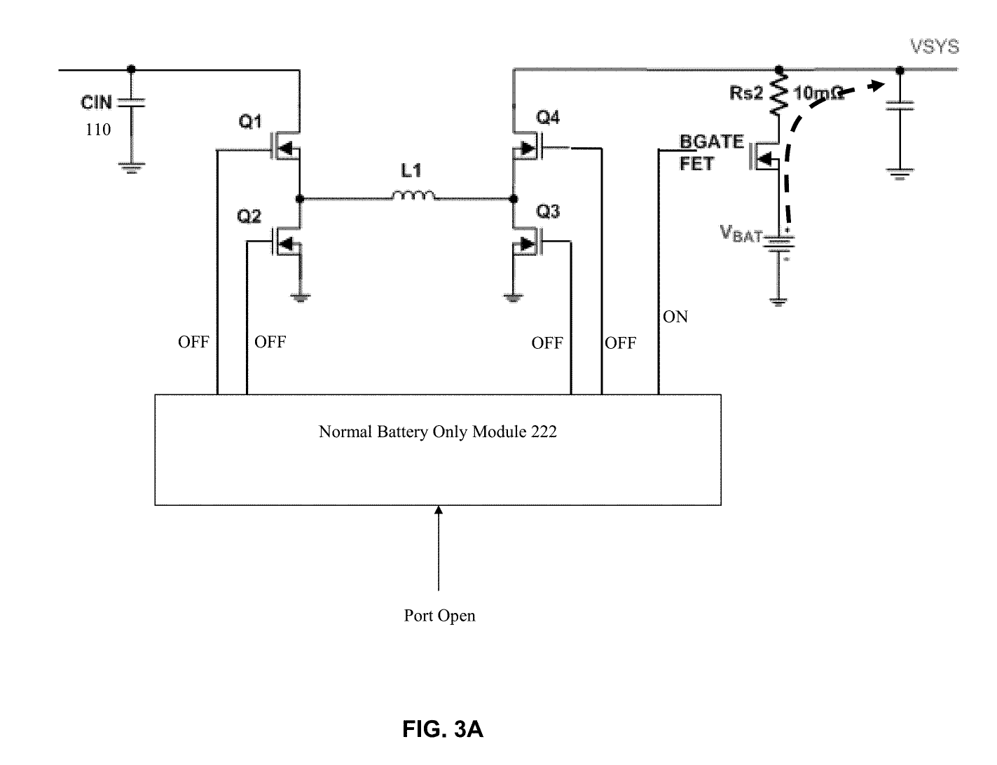

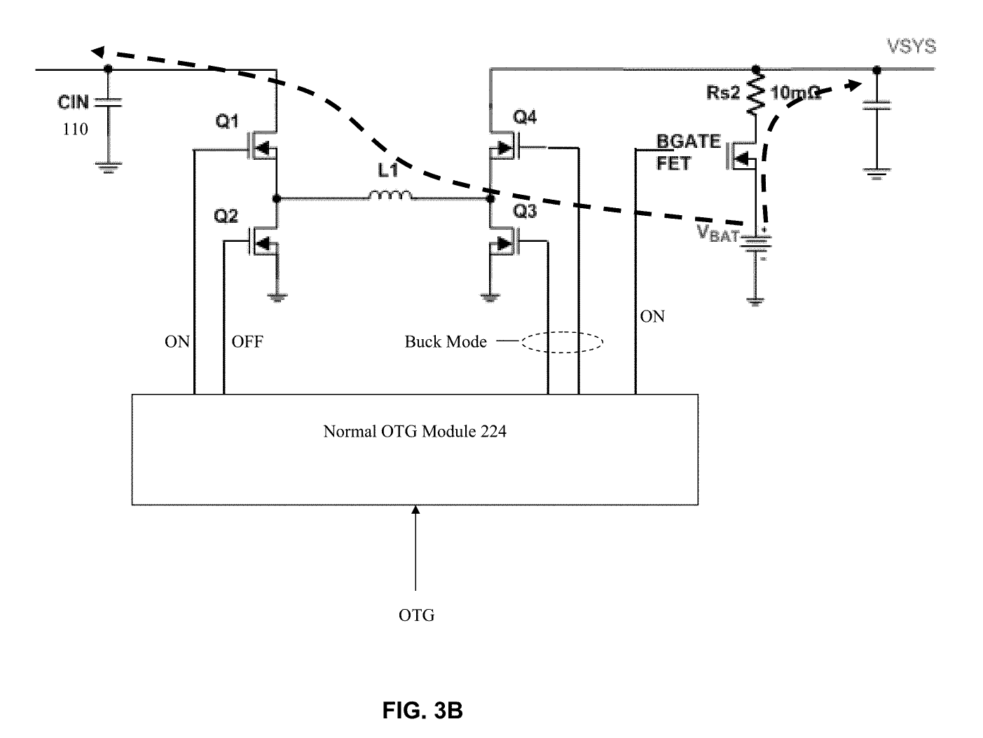

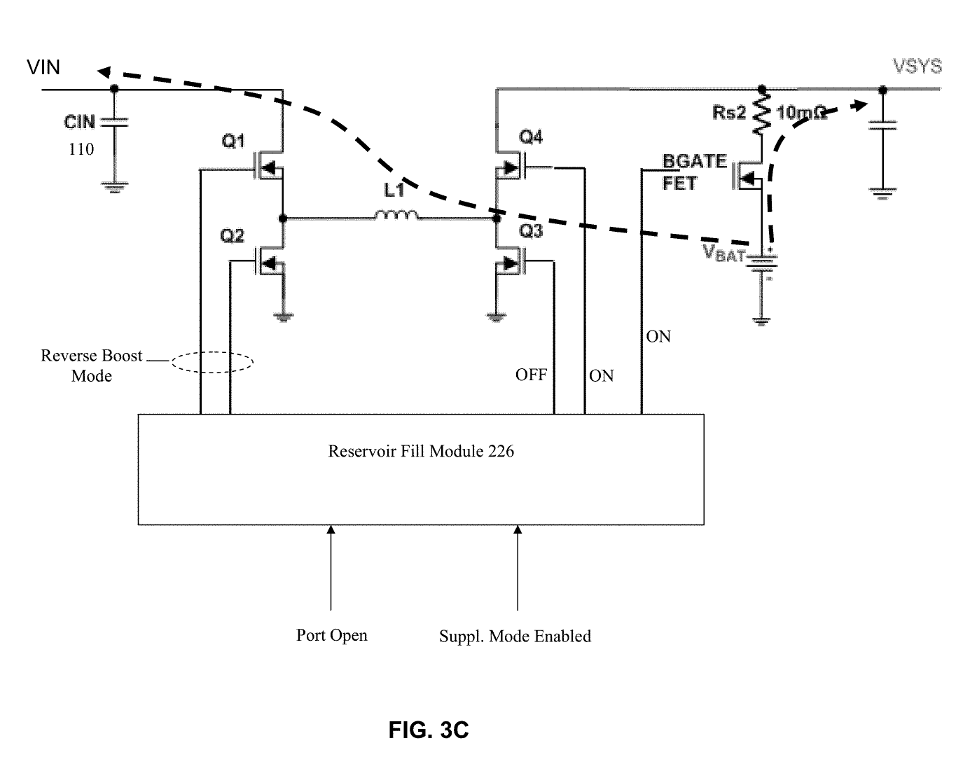

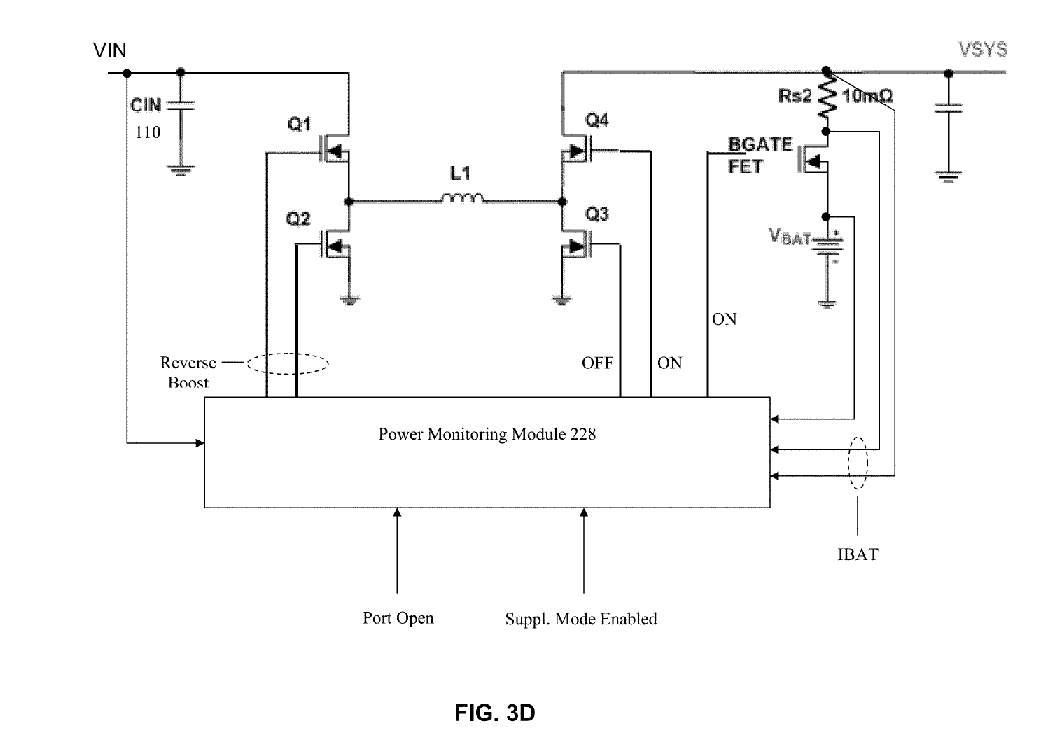

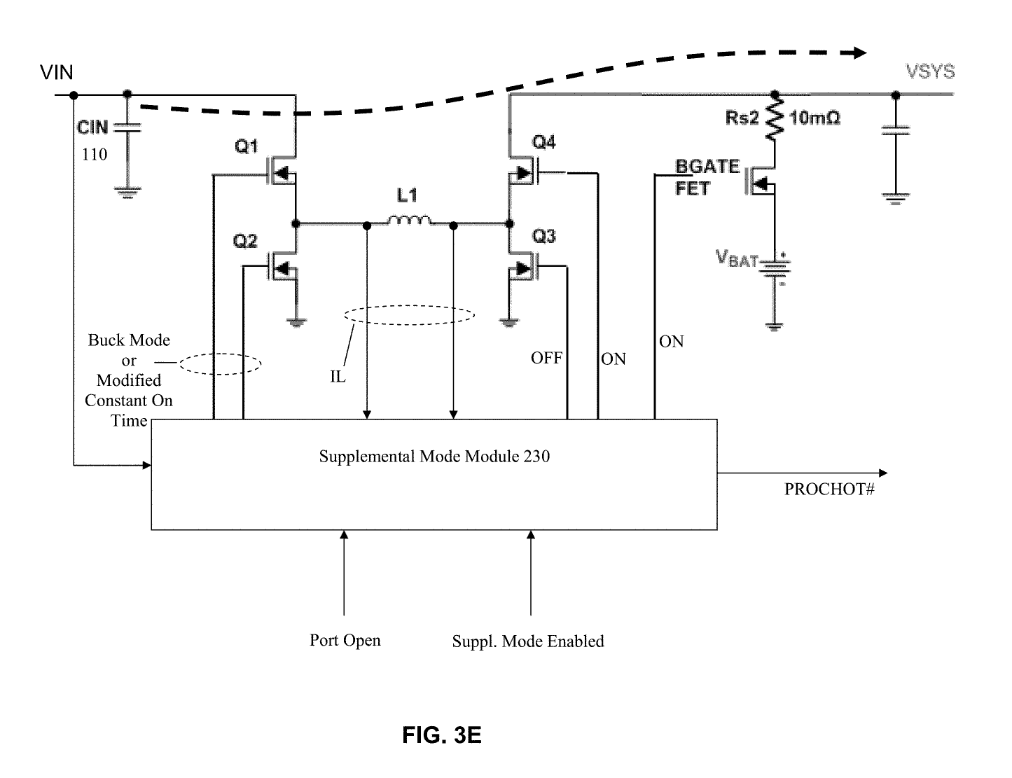

Aspects of how embodiments of IC 202 control transistors Q1, Q2, Q3 and Q4 shown in FIG. 2 will become apparent from the following descriptions and drawings. More particularly, FIGS. 3A to 3E illustrate how the battery charging components of FIG. 2 are managed and/or controlled by IC 202 according to aspects of the present embodiments. Those skilled in the art will understand how to implement modules 222, 224, 226, 228 and 230 after being taught by the present operational descriptions.

FIG. 3A is a schematic diagram illustrating aspects of embodiments operating in a normal battery only mode. As shown, in this mode, no adapter or other device is connected to the USB-C port 106 and/or the USB-C port 106 has been switched to an open state. Initially, the capacitor CIN 110 is fully discharged. When IC 202 receives a port open signal (e.g. from EC 114) indicating no adapter or other device plugged into the USB-C port 106, the normal battery only mode module 222 of IC 202 switches on the BGATE FET 212 which connects the battery 104 to the output node 208. In this case, the normal battery only mode module 202 also switches off all FETs Q1, Q2, Q3 and Q4, so that the battery 104 alone maintains the VSYS voltage on output node 208.

FIG. 3B is a schematic diagram illustrating aspects of embodiments operating in a mode with a battery supplying power to both the system and to an external device using USB conventional OTG functionality. As shown, in this mode, for example after operating in the normal battery only mode shown in FIG. 3A, a slave device is attached to the USB-C port 106, and has negotiated receiving power (e.g. 5V) from system 100 via TCPC 112 for example. This information (e.g., an OTG enable signal) can be communicated from TCPC 112 to IC 202 via EC 114, for example. In response to this information, normal OTG module 224 of IC 202 is activated. Differently from the case in FIG. 3A, module 224 switches on Q1 (or keep off and use the body diode) and operates Q3/Q4 with PWM control, which causes power to be supplied from battery 104 to both output node 208 and to port 106. In an example where battery 104 is a 2S battery having a voltage greater than 5.8V and the attached slave device is operating at a normal 5V USB level, normal OTG module 224 operates Q3/Q4 in buck mode, using PWM control methodologies well known those skilled in the art. Alternatively, OTG module 224 can operate Q3/Q4 in boost mode or buck/boost mode depending on the ratio of the battery voltage to the particular OTG target voltage specified in the OTG request. Also in this mode, in the course of supplying power to port 106, capacitor CIN 110 is charged to the 5V USB level.

FIG. 3C is a schematic diagram illustrating aspects of operating in an initial reservoir filling mode according to embodiments. As shown, in this mode, USB-C port 106 is open and/or no devices are attached as is communicated to IC 202 with a port open signal as described above. Moreover, this mode and reservoir fill module 226 are enabled by IC 202 receiving a supplemental mode enable signal, for example via an SMBus write from EC 114. In this case, reservoir filling module 226 of IC 202 switches off Q3, switches on Q4 and operates Q1/Q2 with PWM control, which causes power to be supplied from battery 104 to both output node 208 and to input capacitor CIN 110. However, differently from the case in FIG. 3B, in response to the supplemental mode enable signal, and the information that port 106 is open, reservoir filling module 226 causes capacitor CIN 110 to be charged up to 20V rather than just 5V. For example, where battery 104 is a 2S battery having a voltage greater than 5.8V, reservoir filling module 226 operates Q1/Q2 in a reverse boost mode, using PWM control methodologies well known to those skilled in the art.

It should be noted that charging voltage level of CIN 110 in reservoir filling mode can be anywhere in a range of 3V-20V, for example depending on the particular use case and the size of capacitor CIN 110. For example, in a case with a very large capacitor CIN 110, the charged voltage level may only be around 7V maximum. In this case, however, and where the battery voltage is 5.8V, the input to output is too close to just buck, and so the higher charged voltage may be preferable.

It should be further noted that this mode can also provide timing and protection for a device plugging into the USB port. For example, in such a situation, reservoir filling module 226 can cause energy in CIN 110 to be returned to the battery or use a switch to GND to return the voltage on the input node to VSAFE0V (or SAFE5V).

FIG. 3D is a schematic diagram illustrating aspects of operating in a power monitoring mode according to embodiments. This mode typically follows directly after the reservoir filling mode illustrated above in connection with FIG. 3C. For example, power monitoring module 228 can monitor the progress of the filling of cap CIN 110 by reservoir filling module 226 by sensing the voltage VIN. When the voltage VIN reaches a threshold level, for example 19.9V, while the port open and supplemental mode enable signals are still on, operation of IC 202 can be automatically switched to being controlled by module 228 rather than module 226.

As shown, in this mode, similar to the case in FIG. 3C, module 228 of IC 202 switches off Q3, switches on Q4 and operates Q1/Q2, which causes power to be supplied from battery 104 to both output node 208 and to input capacitor CIN 110. However, differently from the case in FIG. 3C, where the filling of CIN 110 has already caused VIN to reach a threshold level, power monitoring module 228 operates Q1/Q2 to cause capacitor CIN 110 to maintain a charge of 20V in a trickle charge manner. For example, where battery 104 is a 2S battery having a voltage greater than 5.8V, power monitoring module 228 operates Q1/Q2 in a reverse boost mode, and using PFM control methodologies well known to those skilled in the art. Alternatively, Q1 could be left off to save power and just use the body diode while Q2 is switched to keep the VIN level up to around 20V.

Additionally or alternatively, a charge pump could achieve lower quiescent current. It could be internal to the IC 202 so the switches and caps would be small (less switching loss). The charge pump could take the battery voltage and pump it up by up to 4 times and replace the loss charge on the cap. However, the regulation range would be limited compared to the PFM boost mode.

Also in this mode, power monitoring module 228 monitors the battery 104 current IBAT to the load (e.g. via the voltage drop across Rs2 to the load coupled to VSYS) and voltage VBAT. According to certain aspects, monitoring both battery current and battery voltage provides useful insight as to when to prepare to support the output voltage VSYS.

FIG. 3E is a schematic diagram illustrating aspects of embodiments operating in a supplemental mode according to embodiments. This mode typically follows directly after the power monitoring mode illustrated above in connection with FIG. 3D. For example, as described above, power monitoring module 228 monitors the battery 104 voltage and current and when the voltage of battery droops below 6.2V (or some other threshold level) and the battery current exceeds 1 A (or some other threshold level) while the port open and supplemental mode enable signals are still on, operation of IC 202 can be automatically switched to being controlled by supplemental mode module 230 rather than module 228.

As shown, in response to these battery voltage and current conditions, supplemental mode module 230 operates Q1/Q2 in buck mode, while turning Q4 on (or keep off and use the body diode) and Q3 off, to support VSYS. This causes stored energy in capacitor CIN 110 to be drained from 20V down to a headroom of about 6V in support of VSYS, as monitored by module 230 via the input voltage VIN. Also in response to these battery voltage and current conditions, module 230 asserts the PROCHOT# signal at the same time. This can be used by other circuitry (e.g. CPU 116) to cause the system to reduce frequency and/or shut down components to save power. In some embodiments, after asserting PROCHOT#, module 230 is configured to cause the voltage on VSYS to be supplemented using CIN 110 for a predefined amount of time (e.g., 10 microseconds) to allow time for CPU 116 to respond to the low power condition. Those skilled in the art will understand how to design values of CIN (e.g. 44 μF) and operations of Q1/Q2 based on the particular voltage and timing requirements of a system 100 in which embodiments are implemented. After CIN 110 has been drained and/or a threshold level of VIN is reached, module 230 shuts off Q1/Q2.

In one possible example, module 230 can be configured to operate Q1 with a modified constant on time control scheme, instead of operating Q1/Q2 in a traditional buck mode as described above. More particularly, when the battery voltage first falls below the minimum voltage threshold, supplemental mode module 230 drives the Q1 switch high. Q1 is kept on until VSYS goes above the threshold or until module 230 detects that the inductor current IL reaches a saturation level (e.g. a programmed value), whichever is smaller. The time needed for the inductor current to reach the saturation level is realized through a current source charging a capacitor. If either condition is satisfied, Q1 is turned off. Q1 is kept off until VSYS goes below threshold again and when the inductor current has had sufficient time to fall below a certain threshold (for example, 80% of peak in this case). Once the minimum off time has passed, Q1 is turned on again if VSYS is below the threshold.

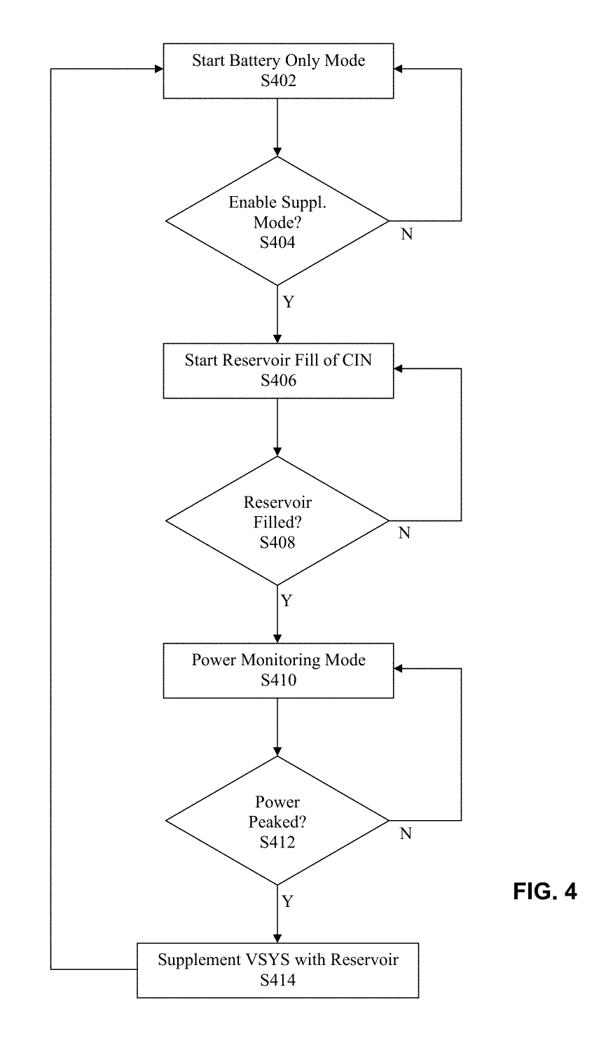

FIG. 4 is a flowchart illustrating aspects of an example methodology according to embodiments such as those shown in the preceding figures.

First, as shown in step S402, battery chargers configured with functionality according to the present embodiments are particularly useful when a computing device is operating a battery only mode. Accordingly, methods according to some embodiments wait in step S402 until a battery only mode is detected. For example, a mobile computing device's port controller such as TCPC 112 can detect when a power adapter is connected to and disconnected from port 106 and communicate this information to EC 114 using well known techniques. EC 114 can then use this information to send a message to battery charger 102, via SMBus writes for example, instructing charger 102 to operate in normal battery only mode.

During normal battery only mode, charger 102 can cause power to be supplied to the system and attached devices using operating functionalities such as those described above in connection with FIGS. 3A and 3B.

In step S404, after detecting a battery only mode, charger 102 further determines whether supplemental mode is enabled. This can be determined by EC 114 and communicated to charger 102 from EC 114, for example using SMBus writes. EC 114 can determine whether to enable or disable this mode based on events such as enabling the mode when TCPC 112 indicates that no external device is attached and disabling the mode when TCPC 112 indicates that an adapter or a device requiring USB OTG operation is attached. Many other enabling or disabling events are possible, such as enabling the supplemental mode when the battery is too discharged, when the system went into sleep or hibernate mode and no current spikes are expected, when the system is overheated, etc. In other embodiments, this mode can also be enabled or disabled using programmable hardware settings in charger 102 such as programmable registers, etc.

After determining that supplemental mode is enabled, operation of charger 102 advances to step S406, where initial reservoir fill mode is started. During this step, charger 102 can cause power to be supplied to the system and to fill CIN 110 up to 20V using operating functionalities such as those described above in connection with FIG. 3C. This operating mode is continued until it is determined that the cap is filled, for example by comparing the input voltage VIN to a threshold such as 19.9V in step S408.

If it is determined in step S408 that the cap is sufficiently filled, operation proceeds to step S410, where preparations are made for activating supplemental mode (i.e. pre-trigger). During this step, charger 102 can cause power to be supplied to the system and to maintain the voltage stored in CIN 110 up to about 20V using operating functionalities such as those described above in connection with FIG. 3D. This mode also includes monitoring certain system power operating parameters such as those described above in connection with FIG. 3D.

In step S412, it is determined whether power has peaked, for example when the battery voltage provided to the output drops to below 5.8V and battery current exceeds 1 A. If so, go to step S414, where supplemental power is provided from the filled input cap CIN 110. During this step, charger 102 can cause power to be supplied to the system from CIN 110 using supplemental mode operating functionalities such as those described above in connection with FIG. 3E. In the example methodology of FIG. 4 according to embodiments, after the reservoir is depleted, processing returns to S402.

Although the present embodiments have been particularly described with reference to preferred ones thereof, it should be readily apparent to those of ordinary skill in the art that changes and modifications in the form and details may be made without departing from the spirit and scope of the present disclosure. It is intended that the appended claims encompass such changes and modifications.

What is claimed is:

1. An apparatus coupled to a battery and a system load, comprising:
input connections for receiving a battery voltage and a battery current; and
a supplemental mode module adapted to provide supplemental power to the system load from a reservoir in response to a predefined weak battery condition indicated by the received battery voltage and current.

2. The apparatus of claim 1, wherein predefined weak battery condition is that both the received battery voltage is below a voltage threshold and the received battery current is above a load threshold.

3. The apparatus of claim 1, further comprising output connections to switching devices, the supplemental mode module controlling the switching devices to provide the supplemental power from the reservoir.

4. The apparatus of claim 3, wherein the switching devices comprise FETs, and the output connections are coupled to gates of the FETs.

5. The apparatus of claim 1, wherein the supplemental mode module is further adapted to provide the supplemental power from the reservoir for a predefined amount of time.

6. The apparatus of claim 5, wherein the reservoir is a capacitor, and wherein the apparatus further comprises a reservoir fill module adapted to charge the capacitor to a level sufficient to provide the supplemental power for the predefined amount of time.

7. The apparatus of claim 6, further comprising output connections to switching devices, the reservoir fill module controlling the switching devices to charge the capacitor from the battery.

8. The apparatus of claim 7, wherein the switching devices comprise FETs, and the output connections are coupled to gates of the FETs.

9. The apparatus of claim 1, wherein the supplemental mode module is further adapted to send a signal to external components in response to the predefined weak battery condition.

10. The apparatus of claim 1, further comprising a power monitoring module that is adapted to monitor the received battery voltage and current and to maintain power in the reservoir until the weak battery condition is detected.

11. A method for controlling an apparatus coupled to a battery and a system load, comprising:
receiving a battery voltage and a battery current; and
providing supplemental power to the system load from a reservoir in response to a predefined weak battery condition indicated by the received battery voltage and current.

12. The method of claim 11, wherein predefined weak battery condition is that both the received battery voltage is below a voltage threshold and the received battery current is above a load threshold.

13. The method of claim 11, wherein the apparatus includes output connections to switching devices, the step of providing supplemental power including controlling the switching devices to provide the supplemental power.

14. The methods of claim 11, wherein providing the supplemental power includes providing the supplemental power from the reservoir for a predefined amount of time.

15. The method of claim 14, wherein the reservoir is a capacitor, the method further comprising charging the capacitor to a level sufficient to provide the supplemental power for the predefined amount of time.

16. The method of claim 15, wherein the apparatus includes output connections to switching devices, the step of charging the capacitor including controlling the switching devices to charge the capacitor from the battery.

17. The method of claim 11, further comprising sending a signal to external components in response to the predefined weak battery condition.

18. The method of claim 11, further comprising monitoring the received battery voltage and current and maintaining power in the reservoir until the weak battery condition is detected.
